(19) United States
(12) Patent Application Publication
(10) Pub. No.: US 2016/0231668 A1
(43) Pub. Date: Aug. 11, 2016

(54) ELECTRIC CONDUCTIVE ROLLER, TRANSFER DEVICE, AND IMAGE FORMING APPARATUS

(71) Applicant: FUJI XEROX CO., LTD., Tokyo (JP)

(72) Inventor: Masato FURUKAWA, Kanagawa (JP)

(73) Assignee: FUJI XEROX CO., LTD., Tokyo (JP)

(21) Appl. No.: 14/818,497

(22) Filed: Aug. 5, 2015

(30) Foreign Application Priority Data
Feb. 9, 2015 (JP) 2015-023295

(51) Int. Cl. G03G 15/16; A01B 29/00

(52) U.S. Cl. CPC G03G 15/1665

(57) ABSTRACT

An electric conductive roller includes a shaft, a cylindrical first elastic body having an electric conductivity and covering the shaft while being in contact with an outer periphery of the shaft, and a second elastic body having an annular shape, disposed at an end portion of the first elastic body, covering the shaft while being spaced apart from the shaft, and having an electric conductivity. The second elastic body has a thickness that gradually increases from a portion between a free end of the second elastic body and a boundary between the second elastic body and the first elastic body to the free end while the second elastic body is retaining an outside diameter greater than or equal to an outside diameter of the first elastic body.

### CROSS-REFERENCE TO RELATED APPLICATIONS

This application is based on and claims priority under 35 USC 119 from Japanese Patent Application No. 2015-023295 filed Feb. 9, 2015.

### BACKGROUND

### Technical Field

The present invention relates to electric conductive rollers, transfer devices, and image forming apparatuses.

### SUMMARY

An electric conductive roller according to an aspect of the invention includes a shaft, a cylindrical first elastic body having an electric conductivity and covering the shaft while being in contact with an outer periphery of the shaft, and a second elastic body having an annular shape, disposed at an end portion of the first elastic body, covering the shaft at a distance from the shaft, and having an electric conductivity, the second elastic body having a thickness that gradually increases from a portion between a free end of the second elastic body and a boundary between the second elastic body and the first elastic body to the free end while the second elastic body is retaining an outside diameter greater than or equal to an outside diameter of the first elastic body.

### BRIEF DESCRIPTION OF THE DRAWINGS

Exemplary embodiments of the present invention will be described in detail based on the following figures, wherein:

FIG. 1 is a schematic diagram (front view) of an image forming apparatus according to an exemplary embodiment;

FIG. 2 is a schematic diagram (partial cross-sectional view) in the vicinity of a second transfer portion in a transfer device according to an exemplary embodiment;

FIG. 3 is a schematic diagram (cross-sectional view) of a second roller constituting a transfer device according to an exemplary embodiment;

FIG. 4 is a schematic diagram (cross-sectional view) of a second roller constituting a transfer device according to a comparative mode;

FIG. 5 is a schematic diagram (partial cross-sectional view) in the vicinity of a second transfer portion in a transfer device according to a comparative mode;

FIG. 6 is a schematic diagram (cross-sectional view) of a modification example (first modification example) obtained by modifying the second roller according to the exemplary embodiment;

FIG. 7 is a schematic diagram (cross-sectional view) of a modification example (second modification example) obtained by modifying the second roller according to the exemplary embodiment;

FIG. 8 is a schematic diagram (cross-sectional view) of a modification example (third modification example) obtained by modifying the second roller according to the exemplary embodiment;

FIG. 9 is a schematic diagram (cross-sectional view) of a modification example (fourth modification example) obtained by modifying the second roller according to the exemplary embodiment;

FIG. 10 is a schematic diagram (cross-sectional view) of a modification example (fifth modification example) obtained by modifying the second roller according to the exemplary embodiment;

FIG. 11 is a schematic diagram (cross-sectional view) of a modification example (sixth modification example) obtained by modifying the second roller according to the exemplary embodiment;

FIG. 12 is a schematic diagram (cross-sectional view) of a modification example (seventh modification example) obtained by modifying the second roller according to the exemplary embodiment; and

FIG. 13 is a list of conditions and results of experiments conducted on examples and comparative modes.

### DETAILED DESCRIPTION

### General Description

The following describes a mode of embodying the invention (referred to as exemplary embodiment, below), followed by description of modification examples obtained by modifying the exemplary embodiment (first to seventh modification examples) and description of examples.

In the following description, directions denoted by arrows X and −X in the drawings indicate an apparatus width direction and directions denoted by arrows Y and −Y in the drawings indicate an apparatus height direction. Directions perpendicular to both the apparatus width direction and the apparatus height direction (directions denoted by arrows Z and −Z) indicate an apparatus depth direction.

### EXEMPLARY EMBODIMENT

Referring now to the drawings, an exemplary embodiment is described below. Firstly, the entire configuration of an image forming apparatus 10 according to an exemplary embodiment is described, followed by description of the configuration of a characteristic portion (transfer device 30) according to the exemplary embodiment, description of the operation of the image forming apparatus 10 according to the exemplary embodiment, and description of effects of the exemplary embodiment.

### Entire Configuration of Image Forming Apparatus

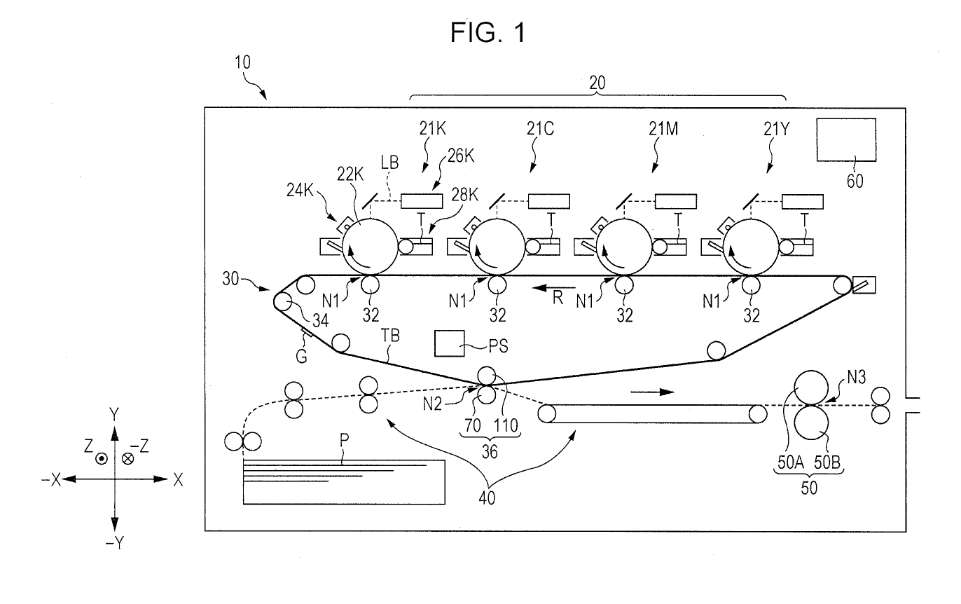

As illustrated in FIG. 1, the image forming apparatus 10 is an electrophotographic apparatus that includes a toner image forming unit 20, a transfer device 30, a transporting device 40, a fixing device 50, and a controller 60.

### Toner Image Forming Unit

The toner image forming unit 20 has a function of forming a toner image G held by a transfer belt TB constituting the transfer device 30 by performing steps of electric charging, exposure to light, and development. The transfer belt TB is described below. Here, the toner image forming unit 20 is an example of a forming unit. The toner image G according to the exemplary embodiment is formed with, for example, a negatively charged toner T.

The toner image forming unit 20 includes single-color units 21Y, 21M, 21C, and 21K that form toner images of different colors, that is, yellow (Y), magenta (M), cyan (C), and black (K). The single-color units 21Y, 21M, 21C, and 21K have the same configuration except for the colors of toner images G that they form. In the following description, the letters of the alphabet (Y, M, C, and K) in the symbols for the single-color units 21Y, 21M, 21C, and 21K are omitted when the single-color units 21Y, 21M, 21C, and 21K and their components do not need to be distinguished from one another. Each single-color unit 21 includes a photoconductor 22, a charging device 24, an exposure device 26, and a developing device 28. The photoconductor 22 is cylindrical. The photoconductor 22 is disposed so that its axis is aligned with the apparatus depth direction. In FIG. 1, reference symbols for the photoconductors 22, the charging devices 24, the exposure devices 26, and the developing devices 28 of the single-color units 21 other than those of the single-color unit 21K are omitted.

### Transfer Device

The transfer device 30 has a function of rotating while holding toner images G of different colors that have been formed at the single-color units 21 and first-transferred to the transfer device 30 and a function of second-transferring, at a nip N2, the toner images F of the different colors onto a transported medium P, described below. The configuration of the transfer device 30 is described below.

### Transporting Device

The transporting device 40 has a function of transporting a medium P so that the medium P passes through a nip N2 and a nip N3, described below.

### Fixing Device

The fixing device 50 has a function of heating and pressing, at the nip N3, toners T constituting toner images G that have been second-transferred to the medium P by the transfer device 30 to fix the toners T onto the medium P. The fixing device 50 includes a heating portion 50A and a pressing portion 50B.

### Controller

The controller 60 has a function of controlling all the components of the image forming apparatus 10 other than itself.

The description given above is about the entire configuration of the image forming apparatus 10 according to the exemplary embodiment.

### Configuration of Characteristic Portion

Referring now to the drawings, a characteristic portion (transfer device 30) according to the exemplary embodiment is described.

As illustrated in FIG. 1, the transfer device 30 includes a transfer belt TB, multiple first rollers 32, a driving roller 34, a second transfer portion 36, and a power source PS. Here, the power source PS is an example of a voltage applying portion.

### Transfer Belt, First Roller, and Driving Roller

The transfer belt TB is an endless belt. Each first roller 32 is disposed below the corresponding photoconductor 22 and forms a nip N1 together with the photoconductor 22 by nipping the transfer belt TB therebetween. Each first roller 32 first-transfers a toner image G of the corresponding color formed on the corresponding photoconductor 22 to the transfer belt TB in response to an application of a voltage (first-transfer voltage) from a power source (not illustrated). The driving roller 34 is driven by a driving source (not illustrated) and rotates around its axis to rotate the transfer belt TB in the direction of arrow R. In this configuration, the transfer belt TB, while rotating in the direction of arrow R, receives toner images G of different colors first-transferred from the single-color units 21 and carries the toner images G of different colors on the outer perimeter to the nip N1. Here, the transfer belt TB is an example of a holding belt. The sheet resistance of the transfer belt TB according to the exemplary embodiment is, for example, 1.0×10⁶ Ω/sq or higher and less than 1.0×10¹⁰ Ω/sq. Here, “sq” denotes a unit volume of 1 m³.

### Second Transfer Portion

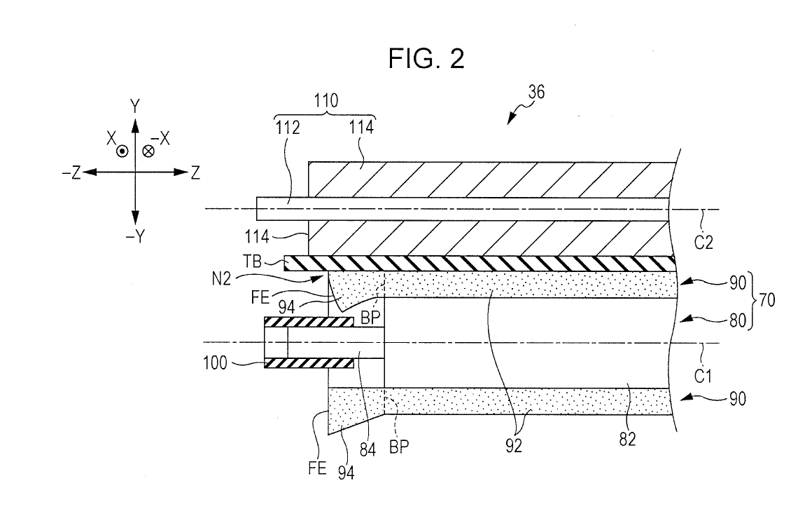

The second transfer portion 36 has a function of second-transferring toner images G of different colors held by the transfer belt TB to a medium P transported by the transporting device 40. As illustrated in FIG. 2, the second transfer portion 36 includes a second roller 70, bearings 100, a back-up roller 110 (hereinafter referred to as a BUR 110), and a movable portion (not illustrated). Here, the second roller 70 is an example of an electric conductive roller. The BUR 110 is an example of a contact portion. FIG. 2 illustrates near-side portions of the second transfer portion 36 and the transfer belt TB in the apparatus depth direction. Far-side portions of the second transfer portion 36 and the transfer belt TB in the apparatus depth direction are symmetric with the near-side portions and have the same configuration.

### Second Roller

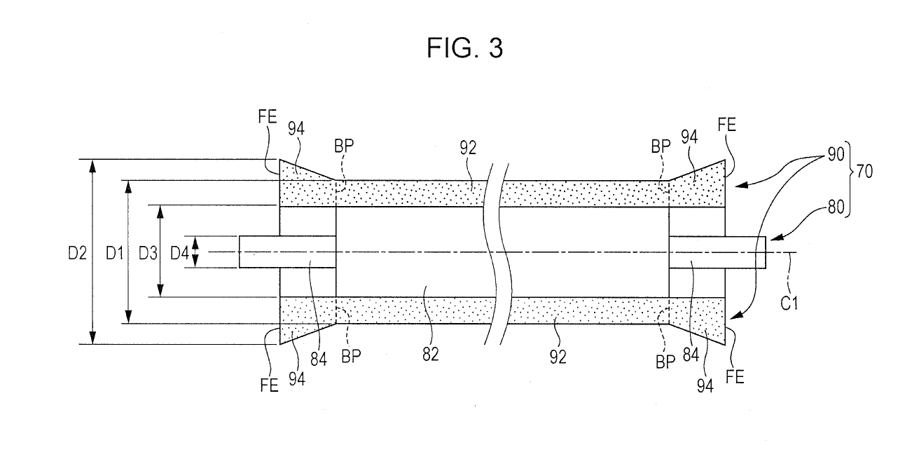

As illustrated in FIGS. 2 and 3, the second roller 70 includes a shaft 80 and an elastic body 90. Here, the shaft 80 is an example of a shaft. The shaft 80 according to the exemplary embodiment is made of metal. The second roller 70 illustrated in FIG. 3 is in an unloaded state, that is, in the state of touching none of other components. In contrast, the second roller 70 illustrated in FIG. 2 is in the state where the second transfer portion 36 is forming a nip N2.

The shaft 80 includes a cylindrical body 82, having a diameter of D3, and protrusions 84, protruding from both longitudinal ends of the body 82 and having a diameter of D4 (<D3). As illustrated in FIG. 3, the shaft 80 is linearly symmetric with respect to its axis (dot-and-dash line C1 in the drawings). The shaft 80 has stepped portions on both axial end portions. A grounded compression spring (not illustrated) in the compressed state touches one end surface of one of the protrusions 84.

The elastic body 90 has electric conductivity. The elastic body 90 includes a first elastic body 92 and second elastic bodies 94. In this description, having electric conductivity means, for example, that the volume resistivity is below 1.0×10⁹ Ω·m. The elastic body 90 according to the exemplary embodiment has, for example, a volume resistivity of 1.0×10⁴ Ω·m or higher and less than 1.0×10⁸ Ω·m. An example of the elastic body 90 according to the exemplary embodiment is an electrically conductive foam (foam containing urethane foam and electrically conductive member).

As illustrated in FIG. 3, the first elastic body 92 is cylindrical (inner diameter of D3 and outside diameter of D1) in the unloaded state. The body 82 of the shaft 80 is fitted into the inner circumference of the first elastic body 92. The first elastic body 92 is bonded to the body 82. The first elastic body 92 thus touches the outer periphery of the body 82 and covers the body 82. Here, the first elastic body 92 is a portion of the elastic body 90 that touches the outer periphery of the body 82 and covers the body 82. The width of the first elastic body 92 (dimension in the direction of axis C1) is equivalent to the width of the body 82 of the shaft 80.

The second elastic bodies 94 are disposed on both longitudinal ends of the first elastic body 92. As illustrated in FIG. 3, each second elastic body 94 is annular in the unloaded state. Here, being annular means being continuous around any axis (axis C1 in the exemplary embodiment) so as to surround the shaft. The inner periphery of each second elastic body 94 has an inner diameter of D3 from a boundary BP between itself and the first elastic body 92 to a free end FE (end opposite to the boundary BP). The outer periphery of each second elastic body 94 has an outside diameter of D1 at the boundary BP and an outside diameter of D2 (=1.03×D1) at the free end FE. The outside diameter of each second elastic body 94 linearly (in relation to the linear function) increases from the boundary BP to the free end FE. In the above-described configuration, each second elastic body 94 covers the corresponding protrusion 84 of the shaft 80 at a distance from the protrusion 84. Each second elastic body 94 gradually thickens from the boundary BP to the free end FE so that its outer diameter keeps being greater than or equal to D1, which is the outside diameter of the first elastic body 92. The second elastic body 94 according to the exemplary embodiment is in the shape of a truncated cone having a hollow in the unloaded state.

As described above, the outside diameter of the first elastic body 92 and the outside diameter of each second elastic body 94 at the boundary BP are D1, and thus D1 and D2 satisfy the inequality D2/D1>1. The outside diameter D2 of each second elastic body 94 at the free end FE is 1.03×D1. Thus, D1 and D2 satisfy the inequality D2/D1≦1.10. Accordingly, in the second roller 70 according to the exemplary embodiment, the outside diameter D1 of the first elastic body 92, the outside diameter D1 of each second elastic body 94 at the boundary BP and the outside diameter D2 of each second elastic body 94 at the free end FE satisfy the inequality 1<D2/D1≦1.10.

### Bearings

The bearings 100 have a function of supporting the second roller 70. As illustrated in FIG. 2, each bearing 100 is cylindrical. The bearings 100 support the second roller 70 in the state where the protrusions 84 at both end portions of the second roller 70 are fitted into the bearings 100. The bearings 100 are attached to a frame (not illustrated) of the transfer device 30. The bearings 100 according to the exemplary embodiment have insulating properties. In this description, having insulating properties means that, for example, the volume resistivity is greater than or equal to 1.0×10¹² Ω·m. The bearings 100 according to the exemplary embodiment have, for example, a volume resistivity of greater than or equal to 1.0×10¹³ Ω·m.

The bearings 100 have a function of preventing electric-current leakages at the protrusions 84 of the shaft 80 and at the second elastic bodies 94 (particularly, at the protrusions 84 and at the free end FE of each second elastic body 94). Thus, as illustrated in FIG. 2, each bearing 100 is disposed so that part of the bearing 100 is located in a space (hollow portion) defined by the inner periphery of the corresponding second elastic body 94.

### BUR and Movable Portion

The BUR 110 has a function of causing the second roller 70 and the transfer belt TB to form a nip N2 by coming into contact with the inner periphery of the transfer belt TB. Thus, as illustrated in FIG. 1 and FIG. 2, the BUR 110 is disposed across from (above) the second roller 70 with the transfer belt TB interposed therebetween.

As illustrated in FIG. 2, the BUR 110 includes a shaft 112 and a resistor 114. The shaft 112 is, for example, a column made of metal. The resistor 114 is cylindrical. The resistor 114 is fitted and bonded to the shaft 112. Both end portions of the shaft 112 protrude beyond the resistor 114. The dot-and-dash line C2 in the drawings denotes the axis of the BUR 110.

The resistor 114 is, for example, an electrically conductive solid rubber and is solider than the elastic body 90 of the second roller 70. Thus, in the state where the nip N2 is formed (in the state where the BUR 110 is in an operation position, described below), the resistor 114 presses the transfer belt TB and squashes the elastic body 90 together with the transfer belt TB. The resistor 114 according to the exemplary embodiment has, for example, a volume resistivity of greater than or equal to 1.0×10³ Ω·m and less than 1.0×10⁴ Ω·m. In other words, the volume resistivity of the resistor 114 is smaller than the volume resistivity of the elastic body 90.

The movable portion (not illustrated) has a function of vertically moving the BUR 110. Specifically, the movable portion includes a pair of bearings (not illustrated), a pair of tension springs (not illustrated), and a pair of cams (not illustrated). The bearings of the pair are fitted to both end portions of the shaft 112. The tension springs of the pair pull the BUR 110 upward in the state where their ends are hooked on the corresponding bearings of the pair. The cams of the pair press the corresponding bearings of the pair in the state of being fixed to both end portions of the shaft (not illustrated). The pair of cams rotate while pressing the pair of bearings as a result of a driving source (not illustrated) rotating the shaft around its axis. In this configuration, the movable portion vertically moves the BUR 110.

Here, FIG. 1 and FIG. 2 illustrate the state where the BUR 110 is disposed in the position (operation position) where an image forming operation is performed. On the other hand, while an image forming operation is not performed (for example, on standby before an image forming operation is performed), the BUR 110 is disposed in a stand-by position (not illustrated) above the operation position while remaining in contact with the inner periphery of the transfer belt TB. In the state where the BUR 110 is disposed in the stand-by position, the nip N2 is unfastened. When the nip N2 is unfastened, the elastic body 90 of the second roller 70 becomes separated from the transfer belt TB and enters the unloaded state illustrated in FIG. 3.

### Power Source

The power source PS has a function of applying a voltage (second transfer voltage) to the BUR 110 and forming an electric field that causes toner images G held on the transfer belt TB to be transferred (second-transferred) to a medium that passes through the nip N2.

During a second transfer, the power source PS applies a voltage having a polarity (negative polarity) the same as the polarity of the toner T to portions of the shaft 112 of the BUR 110 protruding beyond the resistor 114 via leaf springs (not illustrated). As described above, the shaft 80 of the second roller 70 is in contact with the grounded compression spring. When the power source PS applies a negative voltage to the BUR 110 while the BUR 110 is in the operation position, the power source PS forms, at the nip N2, an electric field that causes the toner T held on the transfer belt TB to be transferred (second-transferred) to a medium P. The power source PS according to the exemplary embodiment applies to the shaft 112 of the BUR 110 a voltage within the range of approximately −3 to −2 kV in the standard environment (for example, an environment of a temperature of 23° C. and a humidity of 65%) and a voltage of approximately −9 kV in a low-temperature low-humidity environment (for example, an environment of a temperature of 10° C. and a humidity of 15%).

### Supplement

The following provides supplement on description of the transfer device 30.

### Supplement 1

As illustrated in FIG. 2, portions of the transfer belt TB (both widthwise end portions of the transfer belt TB) and portions of the resistor 114 of the BUR 110 (both axial end portions of the BUR 110) protrude in the axial direction of the second roller 70 beyond the free ends FE of the second elastic bodies 94 of the second roller 70. Portions of the transfer belt TB (both widthwise end portions of the transfer belt TB) protrude in the axial direction of the BUR 110 beyond both axial end portions of the resistor 114 of the BUR 110. Thus, as illustrated in FIG. 2, a portion between the boundary BP and the free end FE of each second elastic body 94 of the second roller 70 forms a nip N2 together with the resistor 114 of the BUR 110 with the transfer belt TB interposed therebetween.

### Supplement 2

As described above (as illustrated in FIG. 2), in the state where the nip N2 is formed, the resistor 114 of the BUR 110 presses the transfer belt TB and squashes the elastic body 90 together with the transfer belt TB. From another point of view, the second roller 70 rotates around its axis in the state where the portion of the elastic body 90 (first elastic body 92 and the second elastic bodies 94) forming the nip N2 is flattened. In this case, the portion of the first elastic body 92 forming the nip N2 is compressed by being nipped by the transfer belt TB and the body 82 of the shaft 80. In contrast, the portions of the second elastic bodies 94 forming the nip N2 are deformed by being pressed by the transfer belt TB but their inner peripheries and their free ends FE do not touch other components (such as the shaft 80 or the bearings 100). As illustrated in FIG. 2, the portions of the second elastic bodies 94 forming the nip N2 are deformed so as to come closer to the protrusions 84 (axis C1) while being spaced apart from the protrusions 84 of the shaft 80. As illustrated in FIG. 2, each second elastic body 94 forms the nip N2 without having a gap between itself and the transfer belt TB throughout the area from the boundary BP and the free end FE.

### Supplement 3

The width of a medium P used in the exemplary embodiment is smaller than the width, in the apparatus depth direction, of a portion of the nip N2 formed by the transfer belt TB and the first elastic body 92. Both widthwise end portions of the medium P thus pass through the nip N2 without deviating from the nip N2 formed by the transfer belt TB and the first elastic body 92.

### Supplement 4

As described above, the outer periphery of the second roller 70 (outer periphery of the elastic body 90) is disposed so as to come into contact with the transfer belt TB at the nip N2. In other words, the transfer belt TB and the second roller 70 (elastic body 90) have such a relation that the second roller 70 touches the transfer belt TB. In other words, the transfer belt TB is an object touched by the second roller 70 (elastic body 90).

The configuration of the image forming apparatus 10 has been described thus far.

### Operation of Image Forming Apparatus

Referring now to the drawings, the operation of the image forming apparatus 10 according to the exemplary embodiment is described.

The controller 60 that has received image data from an outside apparatus (not illustrated) operates the toner image forming unit 20. Then, each toner image forming unit 20 forms a toner image G on the corresponding photoconductor 22 as a result of the corresponding charging device 24 charging the photoconductor 22, the corresponding exposure device 26 exposing the photoconductor 22 to light, and the corresponding developing device 28 developing the toner image G.

Subsequently, each first roller 32 receives an application of a first transfer voltage from the power source (not illustrated) and first-transfers the toner image G formed on the corresponding photoconductor 22 to the rotating transfer belt TB at the nip N1. The movable portion (not illustrated) moves the BUR 110, in the stand-by position, to the operation position and the BUR 110 causes the second roller 70 and the transfer belt TB to form the nip N2. Thereafter, at the time when each toner image G that has been first-transferred to the rotating transfer belt TB and held on the transfer belt TB arrives at the nip N2 together with the transfer belt TB, the transporting device 40 transports a medium P to the nip N2. The power source PS applies a second transfer voltage to the shaft 112 of the BUR 110 and forms an electric field that causes the toner images G held on the transfer belt TB to be transferred to the medium P that passes through the nip N2. As a result, the second transfer portion 36 second-transfers the toner images G on the transfer belt TB to the medium P that passes through the nip N2. Subsequently, the transporting device 40 transports the medium P to a nip N3. Then, the fixing device 50 heats the toner images G second-transferred to the medium P using the heating portion 50A and presses the toner images G using the pressing portion 50B to fix the toner images G to the medium P. The medium P to which the toner images G have been fixed is ejected by the transporting device 40 to the outside of the image forming apparatus 10, whereby the operation of the image forming apparatus 10 is finished.

The operation of the image forming apparatus 10 has been described thus far.

### Effects

Subsequently, effects of the exemplary embodiment are described.

Referring now to the drawings, effects (first and second effects) of the exemplary embodiment are firstly described in comparison with conceivable comparative modes described below. In the description of the comparative modes, components that are the same as those included in the exemplary embodiment are denoted by the same reference symbols.

### Description of Comparative Modes

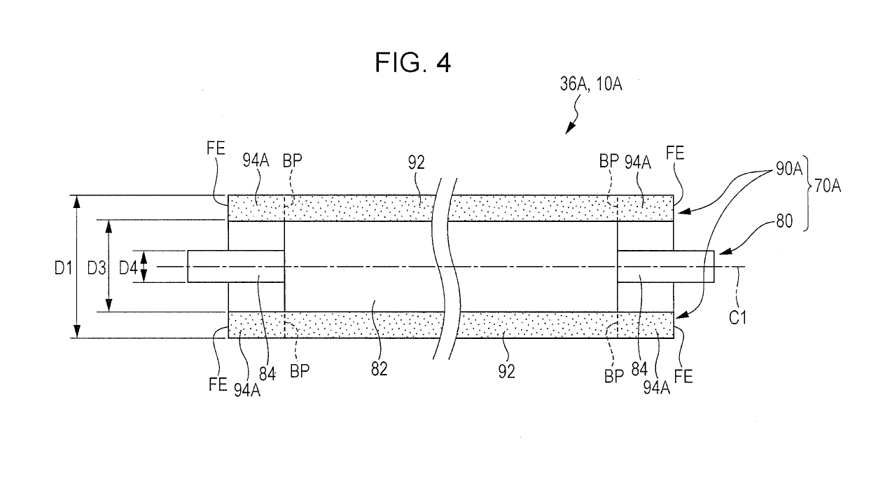

As illustrated in FIG. 4, second elastic bodies 94A constituting a second roller 70A according to a comparative mode are cylinders having an inner diameter of D3 and an outside diameter of D1. Specifically, the inner diameter and the outside diameter of the second elastic bodies 94A are the same as those of the first elastic body 92. The second roller 70A illustrated in FIG. 4 is in the unloaded state. The second roller 70A according to the comparative mode has the same configuration as the second roller 70 according to the exemplary embodiment except for the above-described points. A second transfer portion 36A according to the comparative mode has the same configuration as the second transfer portion 36 according to the exemplary embodiment except that the second transfer portion 36A includes the second roller 70A according to the comparative mode in place of the second roller 70 according to the exemplary embodiment. A transfer device 30A according to the comparative mode has the same configuration as the transfer device 30 according to the exemplary embodiment except that the transfer device 30A includes the second transfer portion 36A according to the comparative mode in place of the second transfer portion 36 according to the exemplary embodiment. An image forming apparatus 10A according to a comparative mode has the same configuration as the image forming apparatus 10 according to the exemplary embodiment except that the image forming apparatus 10A includes the transfer device 30A according to the comparative mode in place of the transfer device 30 according to the exemplary embodiment.

When a second transfer is performed using the transfer device 30A according to the comparative mode, an electric-current leakage may occur between the transfer belt TB and the shaft 80 of the second roller 70A. When an electric-current leakage occurs, an electric current flows from the shaft 80 to the transfer belt TB, failing to form an electric field that causes the toner images G on the transfer belt TB to be second-transferred to a medium P. In addition, when an electric-current leakage occurs between the transfer belt TB and the shaft 80, a second transfer error (a failure in transferring a toner image G to a medium P passing through the nip N2 during the electric-current leakage) occurs at the second transfer portion 36A (transfer device 30A). In the image forming apparatus 10A, an image forming failure attributable to the second transfer error occurs. Such electric-current leakages between the transfer belt TB and the shaft 80 particularly increasingly occur for example when a voltage of approximately −9 kV is applied to the BUR 110 in the low-temperature low-humidity environment.

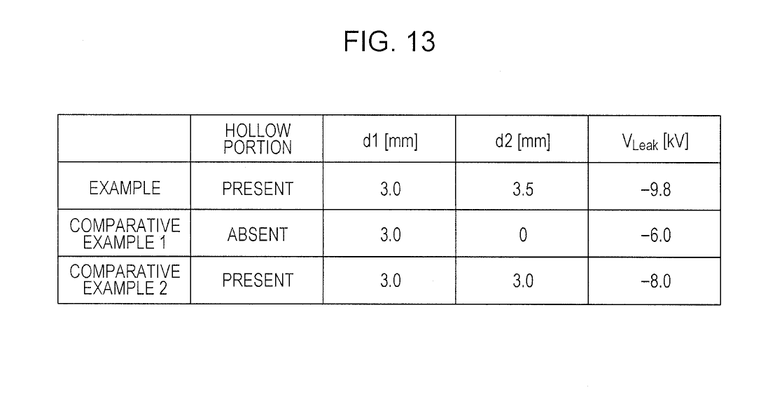

When an electric-current leakage occurs between the transfer belt TB and the shaft 80, an electric current flowing in response to the electric-current leakage presumably flows through a current passage formed between an end portion of the body 82 of the shaft 80 and the transfer belt TB. This current passage is presumed as the shortest route on the surface of each second elastic body 94A (inner periphery and the free end FE) forming the nip N2. As described above, the reason why electric-current leakages between the transfer belt TB and the shaft 80 particularly increasingly occur in the low-temperature low-humidity environment is presumably because a larger quantity of moisture in the atmosphere is more likely to adhere to the surface of the second elastic bodies 94A than in the case of the standard environment. The above-described presumption is believed to be reasonable from the evaluation results of the examples (FIG. 13) described below.

### First Effect

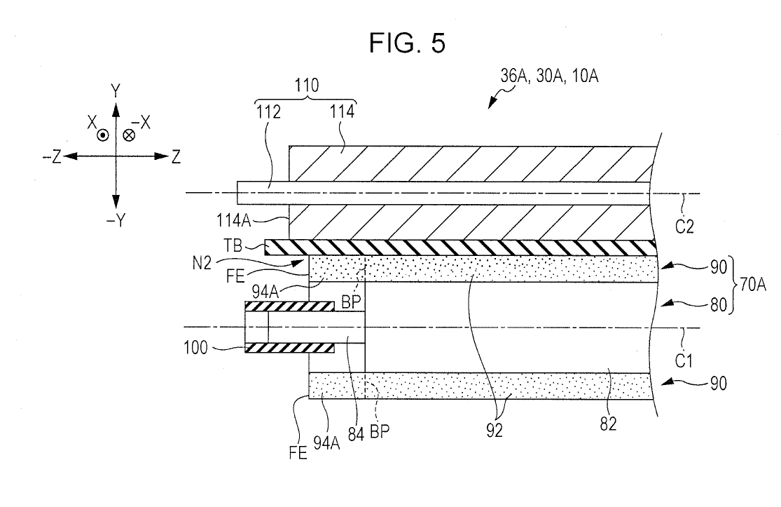

As illustrated in FIG. 3, each second elastic body 94 of the second roller 70 according to the exemplary embodiment gradually thickens from the boundary BP to the free end FE. In the exemplary embodiment, as illustrated in FIG. 2, the portion of each second elastic body 94 forming the nip N2 is deformed so as to come closer to the corresponding protrusion 84 (axis C1) of the shaft 80 while being spaced apart from the protrusion 84. Thus, the electric path (shortest route on the surface, or on the inner periphery and the free end FE, of the second elastic body 94 forming the nip N2) on each second elastic body 94 according to the exemplary embodiment is longer than the electric path on each second elastic body 94A according to the comparative mode (see FIG. 2 and FIG. 5). The electric resistance of the electric path on each second elastic body 94 according to the exemplary embodiment is higher than the electric resistance of the electric path on each second elastic body 94A according to the comparative mode.

Thus, the second roller 70 according to the exemplary embodiment, when constituting the second transfer portion 36, is less likely to cause electric-current leakages (has a higher leakage voltage) at the second elastic bodies 94 than the second roller 70A according to the comparative mode. Accordingly, the transfer device 30 according to the exemplary embodiment is more likely to minimize transfer errors attributable to the electric-current leakages than the transfer device 30A according to the comparative mode. In addition, the image forming apparatus 10 according to the exemplary embodiment is more likely to minimize image forming failures attributable to the transfer errors than the image forming apparatus 10A according to the comparative mode. Here, a leakage voltage is a voltage applied to one of the shaft 112 of the BUR 110 and the shaft 80 of the second roller 70, while the other one of the shafts 112 and 80 is grounded, and a voltage at which an electric-current leakage occurs between the transfer belt TB and the shaft 80. As described above, in the second transfer portion 36 according to the exemplary embodiment, the shaft 80 is grounded and a voltage is applied to the shaft 112. In the second transfer portion 36 according to the exemplary embodiment, a second transfer voltage applied to the shaft 112 is naturally controlled so that it does not exceed the leakage voltage (so that it is smaller than an absolute value of the leakage voltage).

### Second Effect

As illustrated in FIG. 3, unlike the second elastic bodies 94A according to the comparative mode, each of the second elastic bodies 94 of the second roller 70 according to the exemplary embodiment gradually thickens from the boundary BP to the free end FE, so that the outside diameter of the second elastic body 94 increases from D1 from the boundary BP to the free end FE. Thus, even when the second elastic bodies 94 according to the exemplary embodiment are deformed by being pressed by the transfer belt TB, each second elastic body 94 forms the nip N2 without having a gap between itself and the transfer belt TB throughout the area from the boundary BP to the free end FE, as illustrated in FIG. 2. Unlike the second elastic bodies 94 according to the exemplary embodiment, the second elastic bodies 94A according to the comparative mode do not protrude toward the transfer belt TB beyond the outer periphery of the first elastic body 92. In addition, the second elastic bodies 94A according to the comparative mode are thinner than the second elastic bodies 94 according to the exemplary embodiment. Thus, when a nip N2 is formed, the second elastic bodies 94A according to the comparative mode are deformed to a lesser extent and have a smaller reaction force against the transfer belt TB than the second elastic bodies 94 according to the exemplary embodiment. Thus, the second elastic bodies 94A according to the comparative mode are more likely to form a gap between itself and the transfer belt TB over an area from the boundary BP to the free end FE. When a gap is formed between the outer periphery of each second elastic body 94 and the transfer belt TB, an electric-current leakage is more likely to occur in the gap between the outer periphery of the second elastic body 94 and the transfer belt TB. In contrast, the second elastic body 94 according to the exemplary embodiment is less likely to form a gap between itself and the transfer belt TB than the second elastic body 94A according to the comparative mode.

Thus, the second roller 70 according to the exemplary embodiment, when constituting the second transfer portion 36, is less likely to cause an electric-current leakage in a gap between the outer periphery of each second elastic body 94 and the transfer belt TB than the second roller 70A according to the comparative mode. Accordingly, the transfer device 30 according to the exemplary embodiment is more likely to minimize transfer errors attributable to electric-current leakages than the transfer device 30A according to the comparative mode. In addition, the image forming apparatus 10 according to the exemplary embodiment is more likely to minimize image forming failures attributable to transfer errors than the image forming apparatus 10A according to the comparative mode.

Subsequently, third to fifth effects of the exemplary embodiment are described.

### Third Effect

As described above, the second elastic bodies 94 of the second roller 70 according to the exemplary embodiment gradually thicken from the boundary BP to the free end FE and D1 and D2 satisfy the inequality D2/D1≦1.10.

Here, it is presumed that a second roller (not illustrated) having D1 and D2 that satisfy the inequality 1.10<D2/D1 forms a nip N2 together with the transfer belt TB. Second elastic bodies of this presumed second roller have an outside diameter that changes at a higher rate from the boundary BP to the free end FE than the second elastic bodies 94 according to the exemplary embodiment. Specifically, these second elastic bodies have a higher rate of change of the thickness than the second elastic bodies 94 according to the exemplary embodiment. Thus, these second elastic bodies are less likely to be deformed into a nip N2 over an area from the boundary BP to the free end FE, whereby a gap is more likely to be formed between the outer periphery of each second elastic body and the transfer belt TB. In contrast, the second elastic bodies 94 according to the exemplary embodiment are less likely to form a gap between themselves and the transfer belt TB than the second elastic bodies of the second roller having D1 and D2 that satisfy the inequality 1.10<D2/D1.

Thus, the second roller 70 according to the exemplary embodiment, when constituting the second transfer portion 36, is less likely to cause electric-current leakages in a gap between the outer periphery of each second elastic body 94 and the transfer belt TB than the second roller having D1 and D2 that satisfy the inequality 1.10<D2/D1. Accordingly, the transfer device 30 according to the exemplary embodiment is capable of reducing transfer errors attributable to the electric-current leakages further than the transfer device including the second roller having D1 and D2 that satisfy the inequality 1.10<D2/D1. In addition, the image forming apparatus 10 according to the exemplary embodiment is more likely to minimize image forming failures attributable to the transfer errors than the image forming apparatus including the transfer device.

### Fourth Effect

As described above, the second transfer portion 36 according to the exemplary embodiment includes a movable portion (not illustrated). Also as described above, while an image forming operation is not performed, the second roller 70 according to the exemplary embodiment is in the unloaded state, as illustrated in FIG. 3, with the nip N2 being unfastened and the elastic body 90 of the second roller 70 being separated from the transfer belt TB.

Thus, in the second transfer portion 36 according to the exemplary embodiment, the second elastic bodies 94 are less likely to retain permanent deformation than a second transfer portion that does not include a movable portion (or a second transfer portion in which the second roller 70 forms a nip N2 all the time together with the transfer belt TB). Thus, the second transfer portion 36 according to the exemplary embodiment is less likely to cause rotation failures (nonuniform peripheral speed during rotation) in association with the electric-current leakages at the second elastic bodies 94 and the remaining permanent deformation on the second elastic body 94 than a second transfer portion that does not include a movable portion. A second transfer portion that does not include a movable portion and a transfer device and an image forming apparatus that include the second transfer portion are included within the range of the technical scope of the invention.

### Fifth Effect

As described above, the elastic body 90 according to the exemplary embodiment is made of an electrically conductive foam (foam containing urethane foam and an electrically conductive member). Thus, when being rubbed against the transfer belt TB, the second roller 70 according to the exemplary embodiment is less likely to be torn (has a greater tolerance) than, for example, a second roller having a similar shape as the second roller 70 including an elastic body 90 made of nitrile butadiene rubber (NBR or nitrile rubber). A second roller having a similar shape as the second roller 70 and including an elastic body 90 made of nitrile butadiene rubber (NBR or nitrile rubber), a second transfer portion including the second roller, and a transfer device and an image forming apparatus including the second transfer portion are included within the range of the technical scope of the invention.

### MODIFICATION EXAMPLES

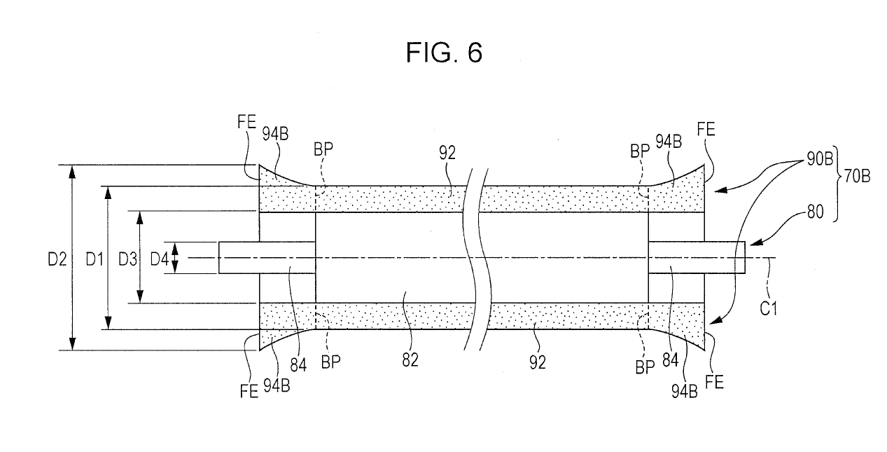

Referring now to FIG. 6 to FIG. 10, modification examples in which the exemplary embodiment is modified are described.

### First Modification Example

### Configuration

As illustrated in FIG. 6, a second roller 70B according to a first modification example has second elastic bodies 94B having a shape different from the shape of the second elastic bodies 94 of the second roller 70 according to the exemplary embodiment. Specifically, the outside diameter of each second elastic body 94B curvedly increases from the boundary BP to the free end FE. In a cross-sectional view taken throughout the axis C1, the outer peripheral edge of each second elastic body 94B forms a curve extending from the boundary BP to the free end FE and recessed toward the axis C1. FIG. 6 illustrates the second roller 70B in the unloaded state. Except for the above-described points, the first modification example has the same configuration as the exemplary embodiment. Here, the second roller 70B according to the first modification example is an example of an electric conductive roller.

### Effects

The effects of the first modification example are similar to those of the exemplary embodiment.

### Second Modification Example

### Configuration

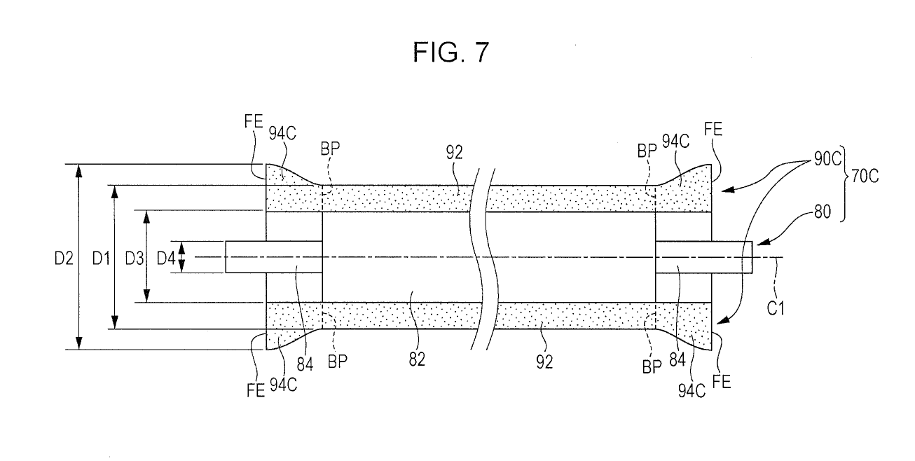

As illustrated in FIG. 7, a second roller 70C according to a second modification example has second elastic bodies 94C that have a shape different from the shape of the second elastic bodies 94 of the second roller 70 according to the exemplary embodiment. Specifically, the outside diameter of each second elastic body 94C curvedly increases from the boundary BP to the free end FE. Here, in a cross-sectional view taken throughout the axis C1, the outer peripheral edge of each second elastic body 94C forms a curve extending from the boundary BP to the free end FE and swelling in the radial directions. FIG. 7 illustrates the second roller 70C in the unloaded state. Except for the above-described points, the second modification example has the same configuration as the exemplary embodiment. Here, the second roller 70C according to the second modification example is an example of an electric conductive roller.

### Effects

The effects of the second modification example are the same as those of the exemplary embodiment.

### Third Modification Example

### Configuration

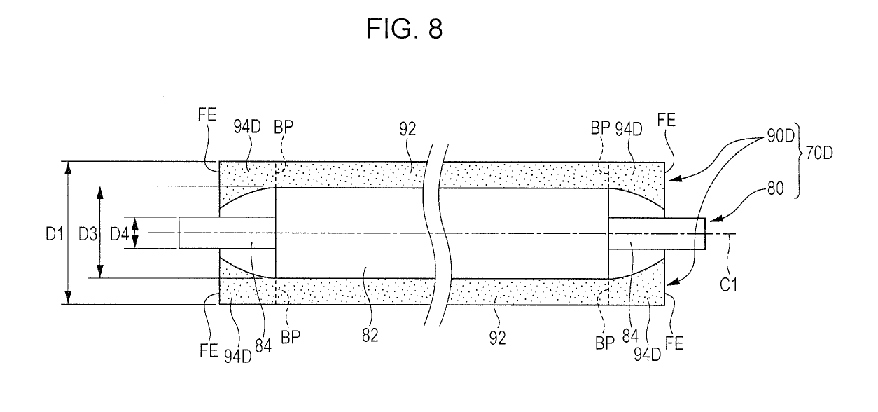

As illustrated in FIG. 8, a second roller 70D according to a third modification example includes second elastic bodies 94D having a shape different from the shape of the second elastic bodies 94 of the second roller 70 according to the exemplary embodiment. Specifically, the outside diameter of each second elastic body 94D remains unchanged as D1 from the boundary BP to the free end FE but the inner diameter of each second elastic body 94D curvedly decreases. Here, in a cross-sectional view taken throughout the axis C1, the inner peripheral edge of each second elastic body 94D forms a curve extending from the boundary BP to the free end FE and recessed in the radial directions. FIG. 8 illustrates the second roller 70D in the unloaded state. Except for the above-described points, the third modification example has the same configuration as the exemplary embodiment. Here, the second roller 70D according to the third modification example is an example of an electric conductive roller.

### Effects

The effects of the third modification example are the same as the first, third, and fifth effects of the exemplary embodiment.

### Fourth Modification Example

### Configuration

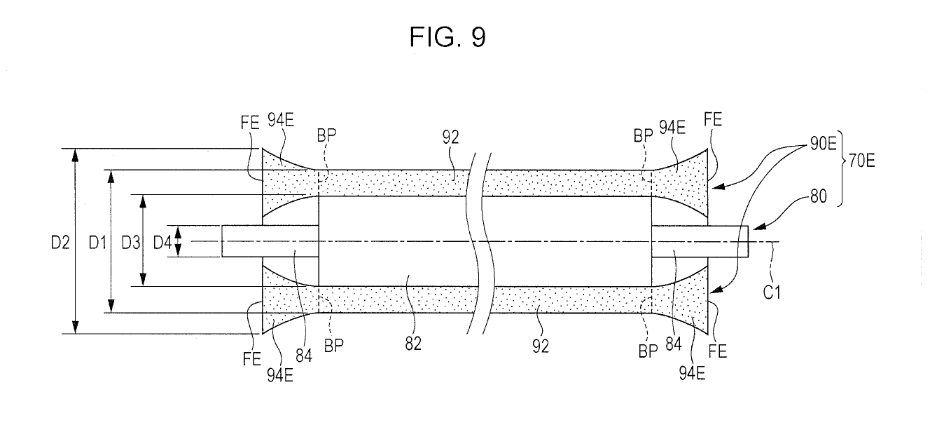

As illustrated in FIG. 9, a second roller 70E according to the fourth modification example includes second elastic bodies 94E having a shape different from the shape of the second elastic bodies 94 of the second roller 70 according to the exemplary embodiment. Specifically, the outside diameter of each second elastic body 94E curvedly increases from the boundary BP to the free end FE whereas the inner diameter of each second elastic body 94E curvedly decreases from the boundary BP to the free end FE. In a cross-sectional view taken throughout the axis C1, the inner peripheral edge of each second elastic body 94E forms a curve extending from the boundary BP to the free end FE and recessed in the radial directions. In a cross-sectional view taken throughout the axis C1, the outer periphery of each second elastic body 94E forms a curve extending from the boundary BP to the free end FE and recessed toward the axis C1. FIG. 9 illustrates the second roller 70E in the unloaded state. Except for the above-described points, the fourth modification example has the same configuration as the exemplary embodiment. Here, the second roller 70E according to the fourth modification example is an example of an electric conductive roller.

### Effects

The effects of the fourth modification example are the same as those of the exemplary embodiment.

### Fifth Modification Example

### Configuration

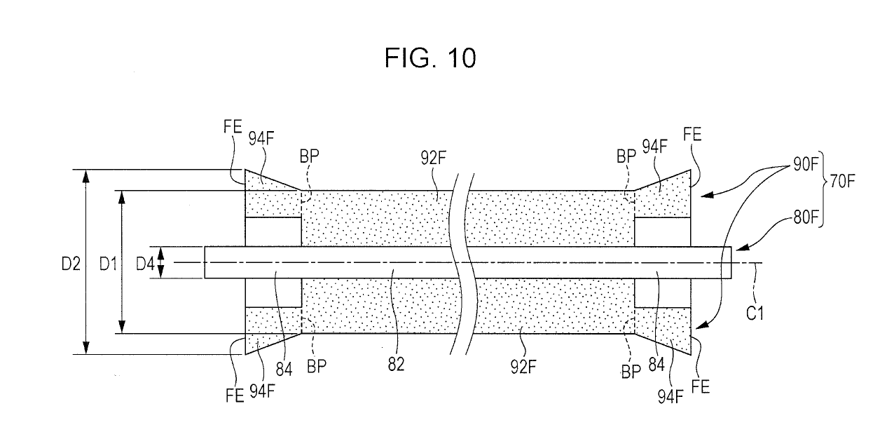

As illustrated in FIG. 10, a second roller 70F according to a fifth modification example includes a shaft 80F and a first elastic body 92F of an elastic body 90F having shapes different from the shapes of the shaft 80 and the first elastic body 92 of the elastic body 90 of the second roller 70 according to the exemplary embodiment. Specifically, the shaft 80F is a column having a diameter of D4 (the diameters of the body 82F and the protrusion 84 are D4). The elastic body 90F includes a first elastic body 92F and second elastic bodies 94F and the inner diameter of the first elastic body 92F is D4. FIG. 10 illustrates the second roller 70F in the unloaded state. Except for the above-described points, the fifth modification example has the same configuration as the exemplary embodiment. Here, the second roller 70F according to the fifth modification example is an example of an electric conductive roller and the shaft 80F according to the fifth modification example is an example of a shaft.

### Effects

The effects of the fifth modification example are the same as those of the exemplary embodiment.

### Sixth Modification Example

### Configuration

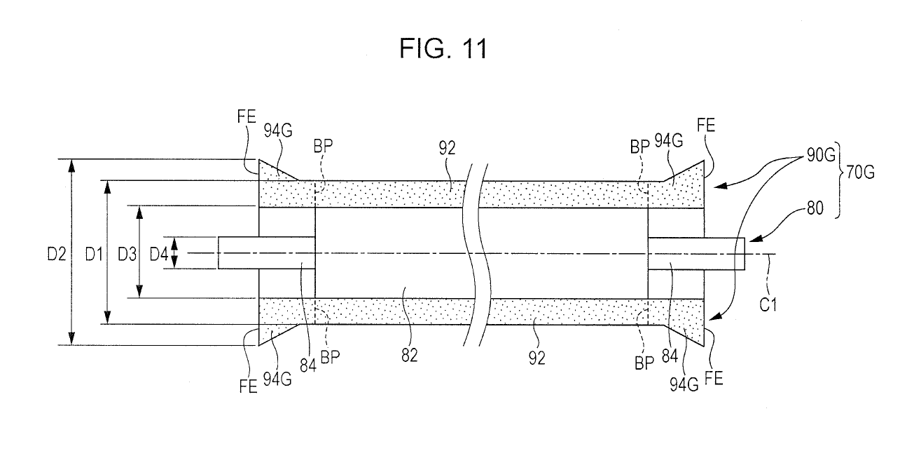

As illustrated in FIG. 11, a second roller 70G according to a sixth modification example includes second elastic bodies 94G having a shape different from the shape of the second elastic bodies 94 of the second roller 70 according to the exemplary embodiment. Specifically, the outside diameter of each second elastic body 94G remains unchanged as D1 from the boundary BP to a fixed portion between the boundary BP and the free end FE (a portion located inward of the free end FE and outward of the boundary BP) and linearly increases from the fixed portion to the free end FE, that is, from the portion near the boundary BP to the free end FE. FIG. 11 illustrates the second roller 70G in the unloaded state. Except for the above-described points, the sixth modification example has the same configuration as the exemplary embodiment. Here, the second roller 70G according to the sixth modification example is an example of an electric conductive roller.

### Effects

The effects of the sixth modification example are the same as those of the exemplary embodiment.

### Seventh Modification Example

### Configuration

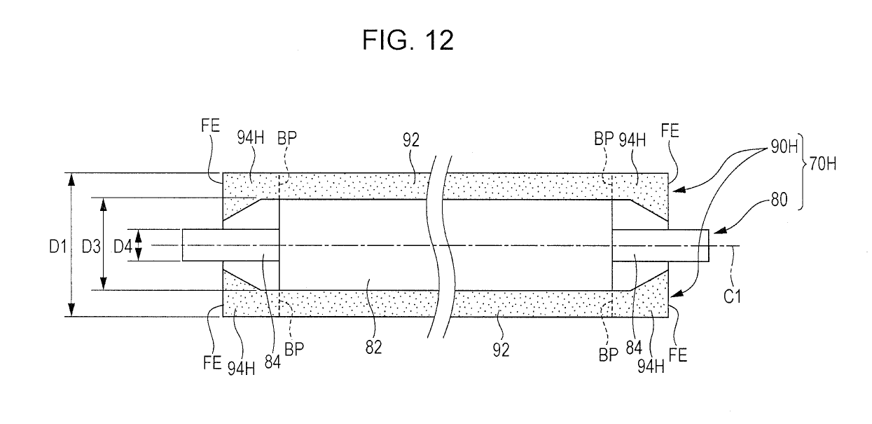

As illustrated in FIG. 12, a second roller 70H according to a seventh modification example includes second elastic bodies 94H having a shape different from the shape of the second elastic bodies 94 of the second roller 70 according to the exemplary embodiment. Specifically, the outside diameter of each second elastic body 94H remains unchanged as D1 from the boundary BP to the free end FE. The inner diameter of each second elastic body 94H remains unchanged as D3 from the boundary BP to a fixed portion between the boundary BP and the free end FE (a portion located inward of the free end FE and outward of the boundary BP) and linearly decreases from the fixed portion to the free end FE, that is, from the portion near the boundary BP to the free end FE. FIG. 12 illustrates the second roller 70H in the unloaded state. Except for the above-described points, the seventh modification example has the same configuration as the exemplary embodiment. Here, the second roller 70H according to the seventh modification example is an example of an electric conductive roller.

### Effects

The effects of the seventh modification example are the same as the first, third, and fifth effects of the exemplary embodiment.

The details of specific exemplary embodiments of the invention have been described thus far. The present invention, however, is not limited to the above-described exemplary embodiments. Other exemplary embodiments are conceivable within the range of the technical scope of the invention.

For example, the second roller 70 according to the exemplary embodiment has been described as a roller used for a second transfer. However, as long as the second roller 70 is usable for forming an electric field, the second roller 70 does not have to be an electric conductive roller used for a second transfer. The second roller 70 may be used as, for example, a charging roller that electrically charges the photoconductor 22, a first transfer roller used for first-transferring a toner image G on the photoconductor 22 to the transfer belt TB, or a roller used for other purposes. The second rollers 70B, 70C, 70D, 70E, 70F, 70G, and 70H according to the modification examples obtained by modifying the second roller according to the exemplary embodiment (first to seventh modification examples, or hereinafter referred to as second rollers according to modification examples) are also similarly usable for other purposes.

It has been described that the second roller 70 according to the exemplary embodiment is grounded and a second transfer voltage is applied to the BUR 110. However, a second transfer voltage may be applied to the second roller 70 and the BUR 110 may be grounded, instead.

In the description of the exemplary embodiments, the second roller 70 according to the exemplary embodiment and the second rollers according to the modification examples have been separately described. However, a second roller obtained by combining the configurations of different second rollers is also included within the range of the technical scope of the invention. For example, the shape of the outer periphery of each second elastic body 94E of the second roller 70E according to the fourth modification example may be changed to the shape of the outer periphery of each second elastic body 94 of the second roller 70 according to the exemplary embodiment, each second elastic body 94B of the second roller 70B according to the first modification example, or each second elastic body 94C of the second roller 70C according to the second modification example.

In the description of the exemplary embodiments, the second elastic bodies 94, 94B, 94C, 94D, 94E, 94F, 94G, and 94H have been described using the second roller 70 according to the exemplary embodiment and the second rollers according to the modification examples as examples. However, the shapes of the second elastic bodies 94, 94B, 94C, 94D, 94E, 94F, 94G, and 94H are not limited to these shapes. Each second elastic body may have any shape as long as it covers the corresponding protrusion 84 of the shaft 80 while being spaced apart from the protrusion 84 and it gradually thickens from the boundary BP to the free end FE while the second elastic body is retaining an outside diameter greater than or equal to the outside diameter D1 of the first elastic body 92.

In the description of the second transfer portion 36 according to the exemplary embodiment, the BUR 110 is vertically moved by a movable portion (not illustrated). Instead, the BUR 110 may be disposed in the operation position without the movable portion being provided to the second transfer portion 36 and the second roller 70 may be made vertically movable by another movable portion (not illustrated).

### EXAMPLES

Referring now to the drawings, examples and comparative examples are described.

### General Description

Hereinbelow, an example and comparative examples (comparative examples 1 and 2) are described. Firstly, second rollers according to the example and the comparative examples were fabricated in the following manner. Then, leakage voltages that occur in the second rollers according to the example and the comparative examples were evaluated. Outstanding properties and evaluation results of the second rollers according to the example and the comparative examples are illustrated in the table in FIG. 13.

### Evaluation Method of Leakage Voltage

Each of the second rollers according to the example and the comparative examples (comparative examples 1 and 2) was attached to DocuCentre-V C7775 (manufactured by Fuji Xerox Corporation). Under the low-temperature low-humidity environment (environment of a temperature of 10° C. and a humidity of 15%), a cyan halftone image was printed over the entirety of an image forming area of an A4-size medium P (plain paper copy paper) and the printed image was observed to evaluate the leakage voltage.

### Second Rollers According to Example and Comparative Examples Second Roller According to Example

The second roller according to the example was shaped like the second roller 70 according to the exemplary embodiment (see FIG. 3). Specifically, the diameter D3 of the body 82 of the shaft 80 was determined as φ14 mm and the width of the body 82 was determined as 330 mm. The diameter D4 of the protrusions 84 of the shaft 80 was determined as φ8 mm and the protrusion length was determined as 20 mm. The elastic body 90 was made of an electrically conductive urethane foam. An elastic body 90 having an outside diameter D1 of φ20 mm and an inner diameter D3 of φ13 mm in the unloaded state was prepared and the shaft 80 was inserted into the elastic body 90 with pressure. Thereafter, both end portions of the elastic body 90 were cut so that the elastic body 90 has a width of 340 mm. In the state where the shaft 80 was inserted into the elastic body 90 with pressure, the elastic body 90 was ground so that a portion of the elastic body 90 covering the body 82 has a thickness of 3 mm. The resultant portion was defined as the first elastic body 92. In addition, the elastic body 90 was ground so that the free ends FE of the second elastic bodies 94 have a thickness of 3.5 mm. The resultant portions were defined as the second elastic bodies 94. The width (dimension in the axial direction) of the second elastic bodies 94 formed on both end portions of the shaft 80 was 5 mm.

### Second Roller According to Comparative Example 1

The second roller (not illustrated) according to the comparative example 1 has the same configuration as the second roller according to the example except that the second roller according to the comparative example does not include the second elastic bodies 94.

### Second Roller According to Comparative Example 2

A second roller according to the comparative example 2 has the same configuration as the second roller according to the example except that the outside diameter of the second elastic bodies 94 is equivalent to the outside diameter of the first elastic body 92 (that is, both thicknesses are 3 mm). The second roller according to the comparative example 2 is shaped like the second roller 70A according to the comparative mode (see FIG. 4). When the second roller according to the comparative example 2 was manufactured, the elastic body 90 was ground while a spacer having an outside diameter of φ14 mm and an inner diameter of φ8 mm was placed in a gap between each protrusion 84 of the shaft 80 and the corresponding second elastic body 94.

### Supplement on Table in FIG. 13

In the table illustrated in FIG. 13, the hollow portion means a gap between each protrusion 84 of the shaft 80 and the corresponding second elastic body 94. The table illustrated in FIG. 13 indicates that each of the second rollers according to the example and the comparative example 2 has a hollow portion, that is, a gap between each protrusion 84 and the corresponding second elastic body 94. In addition, d1 denotes the thickness of the first elastic body 92 and d2 denotes the thickness of each second elastic body 94. Here, d2 in the comparative example 1 is described as zero. This means that the comparative example 1 does not include any second elastic body 94. Thus, the second roller according to the comparative example 1 does not include a hollow portion (that is why the hollow portion column corresponding to the comparative example 1 is filled with “absent” in the table illustrated in FIG. 13).

### Consideration

As illustrated in the table in FIG. 13, the leakage voltage (V_{Leak}) in the second roller according to the example is −9.8 kV under the low-temperature low-humidity environment. Thus, the leakage voltage (V_{Leak}) (or the absolute value of the leakage voltage) in the second roller according to the example is higher than the leakage voltages (V_{Leak}) (or the absolute values of the leakage voltages) in the second rollers according to the comparative examples 1 and 2. Thus, in the second transfer portion 36 that includes the second roller according to the example (a form of the second roller 70 according to the exemplary embodiment), an electric-current leakage is less likely to occur between the shaft 80 and the transfer belt TB under the low-temperature low-humidity environment. When the comparative example 1 and the comparative example 2 are compared with each other, the leakage voltage in the second roller according to the comparative example 2 that includes the second elastic bodies 94 is higher than the leakage voltage in the second roller according to the comparative example 1 that does not include the second elastic bodies 94. From these facts, the results on the table illustrated in FIG. 13 are assumed to reflect the ground for the above-described presumption that an electric current flows through a current passage on each second elastic body 94 during an electric-current leakage, and reflect that the configuration of the second roller 70 according to the exemplary embodiment has the first to third effects.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electric conductive roller, comprising:
a shaft;
a cylindrical first elastic body having an electric conductivity and covering the shaft while being in contact with an outer periphery of the shaft; and
a second elastic body having an annular shape, disposed at an end portion of the first elastic body, covering the shaft while being spaced apart from the shaft, and having an electric conductivity, the second elastic body having a thickness that gradually increases from a portion between a free end of the second elastic body and a boundary between the second elastic body and the first elastic body to the free end while the second elastic body is retaining an outside diameter greater than or equal to an outside diameter of the first elastic body.

2. The electric conductive roller according to claim 1, wherein the outside diameter of the second elastic body increases from the boundary between the second elastic body and the first elastic body to the free end.

3. The electric conductive roller according to claim 1, wherein D1 and D2 satisfy an inequality 1<D2/D1≦1.10, where D1 denotes the outside diameter of the first elastic body and D2 denotes the outside diameter of the second elastic body at the free end.

4. The electric conductive roller according to claim 2, wherein D1 and D2 satisfy an inequality 1<D2/D1≦1.10, where D1 denotes the outside diameter of the first elastic body and D2 denotes the outside diameter of the second elastic body at the free end.

5. A transfer device, comprising:
the electric conductive roller according to claim 1;
an endless holding belt that rotates while holding a toner image on an outer periphery of the holding belt in a state where part of the holding belt protrudes in an axial direction of the shaft beyond the free end;
a contact portion that touches an inner periphery of the holding belt in a state where part of the contact portion protrudes in the axial direction beyond the free end and causes the first elastic body and the holding belt to form a nip; and
a voltage applying portion that applies a voltage to the shaft or the contact portion and forms an electric field that causes the toner image to be transferred to a medium that passes through the nip.

6. An image forming apparatus, comprising:
the transfer device according to claim 5;
a forming unit that forms a toner image held by the holding belt; and
a fixing device that fixes the toner image on the medium that has passed through the nip and to which the toner image has been transferred to the medium.
